(19) United States
(12) Patent Application Publication
(10) Pub. No.: US 2013/0096719 A1
(43) Pub. Date: Apr. 18, 2013

(54) METHOD FOR DYNAMIC OPTIMIZATION OF A ROBOT CONTROL INTERFACE

(71) Applicants: Adam M. Sanders, Holly, MI (US); Matthew J. Reiland, Oxford, MI (US); Douglas Martin Linn, White Lake, MI (US); Nathaniel Quillin, League City, TX (US)

(72) Inventors: Adam M. Sanders, Holly, MI (US); Matthew J. Reiland, Oxford, MI (US); Douglas Martin Linn, White Lake, MI (US); Nathaniel Quillin, League City, TX (US)

(73) Assignees: The U.S.A. As Represented by the Administrator of the National Aeronautics and Space Administration, Washington, DC (US); GM GLOBAL TECHNOLOGY OPERATIONS LLC, Detroit, MI (US)

(21) Appl. No.: 13/272,442

(22) Filed: Oct. 13, 2011

(51) Int. Cl. G05B 15/00; G06F 19/00

(52) U.S. Cl. 700/264; 901/2

(57) ABSTRACT

A control interface for inputting data into a controller and/or controlling a robotic system is displayed on a human-to-machine interface device. The specific configuration of the control interface displayed is based upon the task to be performed, the capabilities of the robotic system, the capabilities of the human-to-machine interface device, and the level of expertise of the user. The specific configuration of the control interface is designed to optimize the interaction between the user and the robotic system based upon the above described criteria.

### STATEMENT REGARDING FEDERALLY SPONSORED RESEARCH OR DEVELOPMENT

This invention was made with government support under NASA Space Act Agreement number SAA-AT-07-003. The invention described herein may be manufactured and used by or for the U.S. Government for U.S. Government (i.e., non-commercial) purposes without the payment of royalties thereon or therefor.

### TECHNICAL FIELD

The invention generally relates to the control of a robotic system, and more specifically to a method of optimizing a control interface between a dexterous robotic machine and a human-to-machine interface device.

### BACKGROUND

Robots are electro-mechanical devices which can be used to manipulate objects via a series of links. The links are interconnected by articulations or actuator-driven robotic joints. Each joint in a typical robot represents an independent control variable or degree of freedom (DOF). End-effectors are the particular links used to perform a given work task, such as grasping a work tool or otherwise acting on an object. Precise motion control of a robot through its various DOF may be organized by task level: object level control, i.e., the ability to control the behavior of an object held in a single or cooperative grasp of the robot, end-effector control, and joint-level control. Collectively, the various control levels cooperate to achieve the required robotic dexterity and work task-related functionality.

Robotic systems include many configuration parameters that must be controlled and/or programmed to control the operation of the robot. A human-to-machine interface device is used to input and/or manage these various configuration parameters. However, as the complexity of the robotic system increases, the complexity and number of the configuration parameters also increases. For example, a traditional industrial robotic arm may include 6 DOF, and may be controlled with a common teach pendant. However, a humanoid robot may include 42 or more degrees of freedom. The configuration parameters required to control and/or program such a humanoid robot are beyond the capabilities of available teach pendants. The robotic system presents these configuration parameters to a user through a control interface displayed on the human-to-machine interface device. Presenting the vast number of configuration parameters to the user requires a complex interface, with many of the configuration parameters not necessary for specific user tasks.

### SUMMARY

A method of optimizing control of a machine is provided. The method includes connecting a human-to-machine interface device to the machine, and selecting a task to be performed. The capabilities of the machine and the capabilities of the human-to-machine interface device are identified, and a pre-defined control interface is displayed. The pre-defined control interface displayed is based upon the selected task to be performed, the identified capabilities of the human-to-machine interface device, and the identified capabilities of the machine. The pre-defined control interface is chosen based upon the above criteria to optimize control of the machine.

A method of controlling a robotic machine is also provided. The method includes defining a plurality of control interfaces. Each of the plurality of control interfaces is configured to optimize interaction between a user and a human-to-machine interface device for a specific task to be performed, for a specific level of expertise of the user, and for specific capabilities of the robotic machine and the human-to-machine interface device. The human-to-machine interface device is connected to the machine. An authorized user having a pre-set level of expertise for operating the robotic machine is authenticated. A task to be performed is selected. The capabilities of the machine and the capabilities of the human-to-machine interface device are identified, and one of the plurality of control interfaces is displayed based upon the selected task to be performed, the identified capabilities of the human-to-machine interface device, the identified capabilities of the machine, and the level of expertise of the user for operating the robotic machine.

A robotic system is also provided. The robotic system includes a dexterous robot having a plurality of robotic joints, actuators configured for moving the robotic joints, and sensors configured for measuring a capability of a corresponding one of the robotic joints and for transmitting the capabilities as sensor signals. A controller is coupled to the dexterous robot. The controller is configured for controlling the operation of the dexterous robot. A human-to-machine interface device is coupled to the controller, and is configured for interfacing with the controller to input data into the controller to control the operation of dexterous robot. The controller includes tangible, non-transitory memory on which are recorded computer-executable instructions, including an optimized control interface module, and a processor. The processor is configured for executing the optimized control interface module. The optimized control interface module includes identifying the capabilities of the dexterous robot, identifying the capabilities of the human-to-machine interface device, authenticating an authorized user of the dexterous robot, and displaying a pre-defined control interface on the human-to-machine interface device. Each authorized user includes a pre-set level of expertise for operating the dexterous robot, and displaying a pre-defined control interface on the human-to-machine interface device is based upon a selected task to be performed, the identified capabilities of the human-to-machine interface device, the identified capabilities of the machine, and the level of expertise of the user for operating the robotic machine.

Accordingly, the control interface displayed on the human-to-machine interface device is optimized for the specific situation to reduce the complexity of the control interface and increase efficiency of the control of the machine. The displayed control interface only presents those control parameters necessary for the specific task to be performed, and hides those control parameters not required for the task, or beyond the level of expertise of the current authenticated user.

The above features and advantages and other features and advantages of the present invention are readily apparent from the following detailed description of the best modes for carrying out the invention when taken in connection with the accompanying drawings.

### BRIEF DESCRIPTION OF THE DRAWINGS

FIG. 1 is a schematic illustration of a robotic system having a controller and a human-to-machine interface device.

FIG. 2 is a flow chart showing a method of optimizing a control interface displayed on the human-to-machine interface device.

### DETAILED DESCRIPTION

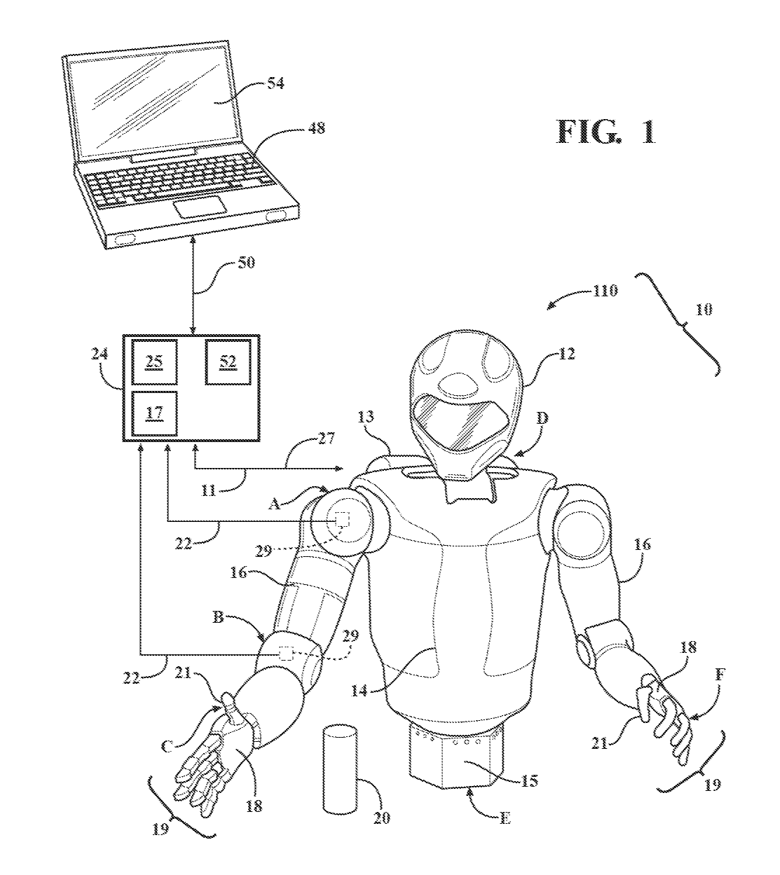

With reference to the drawings, wherein like reference numbers refer to the same or similar components throughout the several views, an example robotic system 10 is shown in FIG. 1. The robotic system 10 includes a machine, such as a dexterous robot 110, a controller 24, and a human-to-machine interface device 48. The controller 24 is configured for controlling the behavior of the robot 110 as the robot executes a given work task or sequence. The controller 24 does so in part by using state classification data generated using information and/or data input into the controller by a user through the human-to-machine interface device 48.

The robot 110 shown in FIG. 1 may be configured as a humanoid in one possible embodiment. The use of humanoids may be advantageous where direct interaction is required between the robot 110 and any devices or systems that are specifically intended for human use or control. Such robots typically have an approximately human structure or appearance in the form of a full body, or a torso, arm, and/or hand, depending on the required work tasks.

The robot 110 may include a plurality of independently and interdependently-moveable compliant robotic joints, such as but not limited to a shoulder joint (indicated generally by arrow A), an elbow joint (arrow B), a wrist joint (arrow C), a neck joint (arrow D), and a waist joint (arrow E), as well as the various finger joints (arrow F) positioned between the phalanges of each robotic finger 19. Each robotic joint may have one or more degrees of freedom (DOF).

For example, certain joints such as the shoulder joint (arrow A), the elbow joint (arrow B), and the wrist joint (arrow C) may have at least two (2) DOF in the form of pitch and roll. Likewise, the neck joint (arrow D) may have at least three (3) DOF, while the waist and wrist (arrows E and C, respectively) may have one or more DOF. Depending on the level of task complexity, the robot 110 may move with over 42 DOF, as is possible with the example embodiment shown in FIG. 1. Such a high number of DOF is characteristic of a dexterous robot, which as used herein means a robot having human-like levels of dexterity, for instance with respect to the human-like levels of dexterity in the fingers 19 and hands 18.

Although not shown in FIG. 1 for illustrative clarity, each robotic joint contains and is driven by one or more joint actuators, e.g., motors, linear actuators, rotary actuators, electrically-controlled antagonistic tendons, and the like. Each joint also includes one or more sensors 29, with only the shoulder and elbow sensors shown in FIG. 1 for simplicity. The sensors 29 measure and transmit sensor signals (arrows 22) to the controller 24, where they are recorded in computer-readable memory 25 and used in the monitoring and/or tracking of the capabilities of the respective robotic joint.

When configured as a humanoid, the robot 110 may include a head 12, a torso 14, a waist 15, arms 16, hands 18, fingers 19, and thumbs 21. The robot 110 may also include a task-suitable fixture or base (not shown) such as legs, treads, or another moveable or stationary base depending on the particular application or intended use of the robot 110. A power supply 13 may be integrally mounted with respect to the robot 110, e.g., a rechargeable battery pack carried or worn on the torso 14 or another suitable energy supply, may be used to provide sufficient electrical energy to the various joints for powering any electrically-driven actuators used therein. The power supply 13 may be controlled via a set of power control and feedback signals (arrow 27).

Still referring to FIG. 1, the controller 24 provides precise motion and systems-level control over the various integrated system components of the robot 110 via control and feedback signals (arrow 11), whether closed or open loop. Such components may include the various compliant joints, relays, lasers, lights, electro-magnetic clamps, and/or other components used for establishing precise control over the behavior of the robot 110, including control over the fine and gross movements needed for manipulating an object 20 grasped by the fingers 19 and thumb 21 of one or more hands 18. The controller 24 is configured to control each robotic joint in isolation from the other joints, as well as to fully coordinate the actions of multiple joints in performing a more complex work task.

The controller 24 may be embodied as one or multiple digital computers or host machines each having one or more processors 17, read only memory (ROM), random access memory (RAM), electrically-programmable read only memory (EPROM), optical drives, magnetic drives, etc., a high-speed clock, analog-to-digital (A/D) circuitry, digital-to-analog (D/A) circuitry, and any required input/output (I/O) circuitry, I/O devices, and communication interfaces, as well as signal conditioning and buffer electronics.

The computer-readable memory 25 may include any non-transitory/tangible medium which participates in providing data or computer-readable instructions. Memory 25 may be non-volatile or volatile. Non-volatile media may include, for example, optical or magnetic disks and other persistent memory. Example volatile media may include dynamic random access memory (DRAM), which may constitute a main memory. Other examples of embodiments for memory 25 include a floppy, flexible disk, or hard disk, magnetic tape or other magnetic medium, a CD-ROM, DVD, and/or any other optical medium, as well as other possible memory devices such as flash memory.

The human-to-machine interface device 48 is coupled to the controller 24, and interfaces with the controller 24 to input data, i.e., configuration parameters, into the controller 24 (arrow 50), which are used to control the operation of robotic machine. The human-to-machine interface device 48 may include but is not limited to, a standard industrial robotic controller 24; tablet, electronic notebook or laptop computer; a desktop computer having a mouse, keyboard, etc; or some other similar device. The specific configuration of the human-to-machine interface device 48 is often determined by the type of task to be performed. For example, if the user is going to program a completely new operation, then the user may use a desktop computer or other similar device as the human-to-machine interface device 48. If the user is going to be tuning and/or debugging an existing operation, than the user may use a notebook computer. If the user is simply going to playback an existing operation, then a standard industrial robotic controller 24 may be used. The human-to machine interface device presents or displays a control interface, through which the user enters the data information into the controller 24.

The controller 24 includes tangible, non-transitory memory 25 on which are recorded computer-executable instructions, including an optimized control interface module 52. The processor 17 of the controller 24 is configured for executing the optimized control interface module 52. The optimized control interface module 52 implements a method of optimizing the control interface of the human-to-machine interface device 48 for controlling the machine. As noted above, the machine may include but is not limited to the dexterous robot 110 shown and described herein. However, it should be appreciated that the below described method is applicable to other robotic machines of varying complexity.

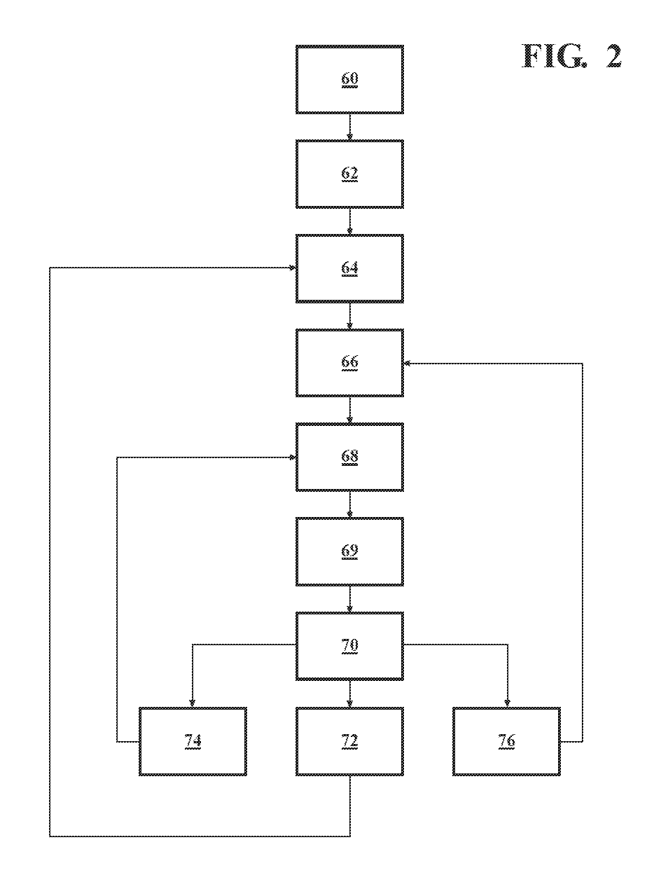

Referring to FIG. 2, the method of optimizing the control interface includes defining a plurality of different control interfaces, indicated by block 60. Each of the different control interfaces is configured to optimize interaction between the user and the human-to-machine interface device 48 for a specific task to be performed, for specific capabilities of the machine, for specific capabilities of and the human-to-machine interface device 48, and for a specific level of expertise of the user.

As noted above, the user may utilize a different human-to-machine interface device 48 for different tasks to be performed. As such, the method includes connecting the human-to-machine interface device 48 to the machine, and more specifically connecting the human-to-machine interface device 48 to the controller 24, indicated by block 62. The human-to-machine interface device 48 may be connected in any suitable manner that allows data to be transferred to the controller 24, including but limited to connecting the human-to-machine interface device 48 to the controller 24 through a wireless network or a hardwired connection. The method of optimizing the control interface may display different configuration parameters for different human-to-machine interface devices 48. For example, a human-to-machine interface device 48 having a high level of input and/or display capabilities, such as a desktop computer, may be presented with a control interface displaying more configuration parameters than a human-to-machine interface having a lower level of input and/or display capabilities, such as standard industrial robotic controllers 24.

Once the human-to-machine interface device 48 is connected to the controller 24, the user may then select a task to be performed, indicated by block 64. The task to be performed may include but is not limited to developing a new operation for the machine to perform, tuning and/or debugging an existing operation, or controlling playback of an existing operation. The method of optimizing the control interface may display different configuration parameters for each different task to be performed. For example, a task of developing a new operation may require a high number of configuration parameters be defined. Accordingly, a control interface displaying the configuration parameters required to develop a new task may be displayed. However, tuning an existing operation may require fewer configuration parameters, in which case the control interface may only display those configuration parameters necessary to tune the existing operation.

The robotic system 10 may require that the user be authenticated, indicated by block 66, prior to displaying the pre-defined control interface. A user account may be established for each user of the human-to-machine interface device 48. Each user account defines a level of expertise for that user. The level of expertise is a setting that defines the level of knowledge that each particular user has with the robotic system 10. The method of optimizing the control interface may display different configuration parameters for users having a different level of expertise. For example, a user having a high level of expertise may be presented with a control interface displaying more configuration parameters than a user having a lower level of expertise.

The capabilities of the machine and the capabilities of the human-to-machine interface device 48 are identified, indicated by block 68. The robot 110 may include so much sensing that it may be overwhelming to display many of the sensors that aren't being used, such as the 6 degree of freedom phalange sensors. Also the robot 110 is adjustable for how many of these sensors are included in the particular robot 110 from 0-14 per hand. Other advanced sensors include sensors like a 3D Swiss Ranger. The robot 110 can also dynamically change the data that it requires when it is put into different modes, for example, the arm and waist joints can be run in a torque controlled, position controlled, impedance controlled, or velocity controlled mode. Each of the modes would require a different style of command to properly operate the robot 110.

Some of the capabilities of the interface device 48 are limited by the input device. Since the robot is initially programmed in a flowchart style graphical way, a larger high resolution screen may be used to see the flow of the program and also how blocks connect. For general touchup, a smaller netbook style computer will reduce the graphical interface content to more important items relating to the running of the robot so that everything isn't simply shrunk to an unreadable size. Finally for the general running of a finished program the interface is reduced even further to only the basic commands and feedback to operate the robot with very limited user interaction of the program. The interface device 48 may also show functionality when external interfaces are connected such as Manufacturing PLC type equipment, Vision System Data, Teleoperation Hardware, and external algorithms such as learning and dynamic path planning.

Identifying the capabilities of the machine may include, for example, identifying a total number of degrees of freedom of the machine, a speed of movement of the machine and/or of each robotic joint, sensor capabilities of the machine, or operating modes of the machine. Identifying the capabilities of the human-to-machine interface device 48 may include, for example, identifying visual display capabilities, input/output capabilities, audio capabilities, or display screen size and resolution. The capabilities of the robotic machine and the capabilities of the human-to-machine interface device 48 may be identified in any suitable manner. For example, the controller 24 may query the robotic machine and/or the human-to-machine interface device 48 to identify the various components of each and the physical and/or electronic capabilities thereof. Alternatively, the robotic machine and/or the human-to-machine interface device 48 may send signals to and/or between the controller 24 to identify the various components of each and the different capabilities thereof. In accordance with the method of optimizing the control interface, the controller 24 may display different configuration parameters for different capabilities of the robotic machine and/or the human-to-machine interface device 48. For example, a robotic machine having a high level of capabilities may be presented with a control interface displaying more configuration parameters than a robotic machine having limited capabilities. Similarly, a human-to-machine interface device 48 having a high level of capabilities may be presented with a control interface displaying more configuration parameters than a human-to-machine interface device 48 having limited capabilities.

After the capabilities of the robotic machine and the human-to-machine interface device 48 have been identified, the task to be performed has been selected, and the user has been authenticated, thereby providing a level of expertise of the user related to the robotic system 10, then the controller 24 determines, indicated by block 69, which one of the pre-defined control interfaces optimizes the interaction between the user and the controller for the given criteria. Once the controller 24 determines which of the control interfaces is the optimum, then the selected control interface is displayed, indicated by block 70, on the human-to-machine interface device 48. The specific control interface that is displayed, generally indicated at 54 in FIG. 1, is based upon the selected task to be performed, the identified capabilities of the human-to-machine interface device 48, the identified capabilities of the machine to optimize the control of the machine, and the level of expertise of the authenticated user. The displayed control interface only displays the configuration parameters required for the task to be performed, and hides unnecessary configuration parameters that are not necessary and/or that are beyond the level of expertise, i.e., beyond the understanding, of the current user. Furthermore, the displayed control interface is optimized for the specific capabilities of the human-to-machine interface device 48 as well as the capabilities of the robotic machine. Such optimization improves efficiency in operating the machine by reducing the complexity of the control interface. The reduced complexity of the control interface further reduces training time for training new users. By limiting the configuration parameters displayed based upon the level of expertise of the user, the displayed control interface prevents an unskilled user from accessing potentially hazardous and/or damaging commands.

If a new task to be performed is selected, generally indicated by block 72, the human-to-machine interface device 48 is changed, generally indicated by block 74, or that a different user having a different level of expertise is authenticated, generally indicated by block 76, then a new control interface 54 may be displayed to thereby optimize the control interface for the new criteria.

While the best modes for carrying out the invention have been described in detail, those familiar with the art to which this invention relates will recognize various alternative designs and embodiments for practicing the invention within the scope of the appended claims.

1. A method of optimizing control of a machine, the method comprising:
connecting a human-to-machine interface device to the machine;
selecting a task to be performed;
identifying the capabilities of the machine and the capabilities of the human-to-machine interface device; and
displaying a pre-defined control interface based upon the selected task to be performed, the identified capabilities of the human-to-machine interface device, and the identified capabilities of the machine to optimize the control of the machine.

2. A method as set forth in claim 1 wherein selecting a task to be performed includes selecting a task from a group of tasks including developing a new operation for the machine to perform, tuning an existing operation, or controlling playback of an existing operation.

3. A method as set forth in claim 1 wherein identifying the capabilities of the machine include identifying a total number of degrees of freedom of the machine, a speed of movement of the machine, the sensors of the machine, or the available operating modes of the machine.

4. A method as set forth in claim 3 wherein identifying the capabilities of the human-to-machine interface device includes identifying visual display capabilities, input/output capabilities, audio capabilities, screen display size or screen resolution.

5. A method as set forth in claim 1 further comprising defining a plurality of control interfaces, with each of the plurality of control interfaces configured to optimize interaction between a user and the human-to-machine interface device for a specific task to be performed and for specific capabilities of the machine and the human-to-machine interface device.

6. A method as set forth in claim 1 further including authenticating an authorized user prior to displaying the pre-defined control interface.

7. A method as set forth in claim 6 further comprising establishing a user account for each user of the human-to-machine interface device.

8. A method as set forth in claim 7 further comprising defining a level of expertise for each user account.

9. A method as set forth in claim 8 wherein displaying a pre-defined control interface based upon the selected task to be performed, the identified capabilities of the human-to-machine interface device, and the identified capabilities of the machine further includes displaying the pre-defined control interface based upon the level of expertise of the authenticated user.

10. A method as set forth in claim 9 further comprising defining a plurality of control interfaces, with each of the plurality of control interfaces configured to optimize interaction between a user and the human-to-machine interface device for a specific task to be performed, for the specific capabilities of the machine and the human-to-machine interface device, and for the level of expertise of the authenticated user.

11. A method as set forth in claim 1 wherein the machine includes a dexterous robot having a plurality of robotic joints, actuators configured for moving the robotic joints, and sensors configured for measuring a capability of a corresponding one of the robotic joints.

12. A method of controlling a robotic machine, the method comprising:
defining a plurality of control interfaces, with each of the plurality of control interfaces configured to optimize interaction between a user and a human-to-machine interface device for a specific task to be performed, for a specific level of expertise of the user, and for specific capabilities of the machine and the human-to-machine interface device;
connecting the human-to-machine interface device to the machine;
authenticating an authorized user having a pre-set level of expertise for operating the robotic machine;
selecting a task to be performed;
identifying the capabilities of the machine and the capabilities of the human-to-machine interface device; and
displaying one of the plurality of pre-defined control interfaces based upon the selected task to be performed, the identified capabilities of the human-to-machine interface device, the identified capabilities of the machine, and the level of expertise of the user in operating the robotic machine.

13. A method as set forth in claim 12 wherein selecting a task to be performed includes selecting a task from a group of tasks including developing a new operation for the machine to perform, tuning an existing operation, or controlling playback of an existing operation.

14. A method as set forth in claim 13 wherein identifying the capabilities of the machine include identifying a total number of degrees of freedom of the machine, a speed of movement of the machine, the sensors of the machine, or the available operating modes of the machine.

15. A method as set forth in claim 14 wherein identifying the capabilities of the human-to-machine interface device includes identifying visual display capabilities, input/output capabilities, audio capabilities, screen display size or screen resolution.

16. A method as set forth in claim 15 wherein the robotic machine includes a dexterous robot having a plurality of robotic joints, actuators configured for moving the robotic joints, and sensors configured for measuring a capability of a corresponding one of the robotic joints.

17. A robotic system comprising:
a dexterous robot having a plurality of robotic joints, actuators configured for moving the robotic joints, and sensors configured for measuring a capability of a corresponding one of the robotic joints and for transmitting the capabilities as sensor signals;
a controller coupled to the dexterous robot and configured for controlling the operation of the dexterous robot; and
a human-to-machine interface device coupled to the controller and configured for interfacing with the controller to input data into the controller to control the operation of the dexterous robot;
wherein the controller includes:
tangible, non-transitory memory on which is recorded computer-executable instructions, including an optimized control interface module; and
a processor configured for executing the optimized control interface module, wherein the optimized control interface module is configured for:
identifying the capabilities of the dexterous robot;
identifying the capabilities of the human-to-machine interface device;
authenticating an authorized user of the dexterous robot, wherein each authorized user includes a pre-set level of expertise for operating the dexterous robot; and
displaying a pre-defined control interface on the human-to-machine interface device based upon a selected task to be performed, the identified capabilities of the human-to-machine interface device, the identified capabilities of the machine, and the level of expertise of the user for operating the robotic machine.
